(19) United States
(12) Patent Application Publication
(10) Pub. No.: US 2009/0052767 A1
(43) Pub. Date: Feb. 26, 2009

(54) Modelling

(76) Inventors: Abhir Bhalerao, Leamington Spa (GB); Li Wang, Coventry (GB); Roland Wilson, Lichfield (GB)

Correspondence Address: Abhir Bhalerao;217, Rugby Road, Leamington Spa, CV32 6DY, GB

(21) Appl. No.: 11/843,805

(22) Filed: Aug. 23, 2007

(30) Foreign Application Priority Data
Aug. 23, 2007 (GB) GB 0616685.4

(51) Int. Cl. G06K 9/00

(52) U.S. Cl. 382/154

(57) ABSTRACT

A method of modelling an object (313), comprising capturing images of the object from a plurality of spaced apart cameras (310), creating a three-dimensional model (31) of the object from the images and determining from the model and the images a lighting model (36) describing how the object is lit. Typically, the method comprises the step of estimating the appearance of the object if it were evenly lit; and minimising the entropy in the estimated appearance of the object. Similarly, also disclosed is a method of determining how a two-dimensional image is lit, comprising capturing the image (21), modelling the lighting of the image and removing the effects of the lighting, in which the method comprises calculating the entropy of the image with the effects of the lighting removed and selecting the model such that the entropy is minimised.

This invention relates to methods and apparatus for modelling.

Estimating the location and effect of lighting and shading of an imaged scene from one of more camera views is an interesting and challenging problem in computer vision, and it has a number of important applications.

If a view independent model of the lighting can be obtained with knowledge of only the colours of surface elements of the scene, for example, in the form of a patch-based representation (Mullins et al, “Estimation Planar Patches from Light Field Reconstruction”, Proceedings of BMVC 2005, 2005), then the scene can be correctly lit when viewed from a different viewpoint or objects in the scene are moved. The common assumption is that the surfaces in the scene have only diffuse reflectance (the Lambertian assumption) when incident light is reflected equally in all directions. This assumption is violated by shiny surfaces that give rise to specular highlights, which are view dependent. Also, if scene elements occlude the light source then shadows will be created. These are view independent, but will change with the lighting or the motion of objects. Furthermore, if a scene is augmented with virtual objects, they can be lit correctly only with knowledge of the scene lighting.

Multiview reconstruction algorithms, such as image based rendering (IBR), take many camera images of the same scene and attempt to reconstruct a view from an arbitrary viewpoint. If the number of views is large then it may be possible to estimate the 3D shape of the scene rather than just the depth of corresponding pixels between camera views. Indeed, the various multiview reconstructions techniques are characterised by how much of the scene is explicitly modelled, although disparity compensation is always required. In photo-consistency methods, only a dense depth-estimate is used (Weber et al, “Towards a complete dense geometric and photometric reconstruction under varying pose illumination”, Proceedings of BMVC, 2002) whereas in depth-carving is a volumetric approach starts with multiple silhouettes and results in a mesh description of the object. However, it was demonstrated that knowing orientation of surface elements (patches), as well as their depth, produces excellent reconstructions without having to resort to a mesh model (Mullins et al, cited above). The lighting of the scene, especially view-dependent artefacts, confound disparity estimation, therefore any knowledge of the scene lighting is vital to improving the scene estimation stage. Also, the viewpoint reconstruction techniques, e.g. light field reconstruction, can either ignore non-Lambertian surface properties or incorporate these into the noise model when reconstructing from a novel view. If the non-Lambertian artefacts can be accommodated by the shape estimation method, then one approach is to estimate their location and remove from the generated texture maps for reconstruction e.g. by using a multi-view shape-from shading algorithm (Samaras et al, “Variable albedo surface reconstruction from Stereo and Shape from Shading” CVPR 2000, pages 480-487, 2000). Alternatively, the surface reflectance can be explicitly modelled, such as by the use of View Independent Reflectance Map (VIRM) (Yu et al, “Shape and View Independent Reflectance Map from Multiple Views” Proceedings of ECCV, 2004) and is shown to work well for few cameras. The tensor-field radiance model in Jin's work (Yezzi et al, “Multi-view Stereo beyond Lambert”, CVPR 2003, pages 171-178, 2003) was effective for dense camera views. In both these approaches, the consistency of a non-Lambertian reflectance model to the corresponding pixels from multiple views is a constraint on the evolving model of surface geometry, which is being simultaneously estimated.

According to a first aspect of the invention, we provide a method of modelling an object, comprising capturing images of the object from a plurality of spaced apart cameras, creating a three-dimensional model of the object from the images and determining from the model and the images a lighting model describing how the object is lit.

This therefore provides a method of determining from the captured images of the object how the object is lit. It need not depend on any separate calibration of the lighting or the provision of a standard object; furthermore, it may advantageously be carried out without any user intervention.

In the preferred embodiment, the position of the cameras relative to one another is known. By calibrating the positions of the cameras, a more accurate estimation of the surface of the object can be made, which can lead to a more accurate estimation of the lighting of the object. Estimating the shape of an object in this way is known (the current invention is considered to lie in the subsequent processing to estimate how the object is lit) and as such a method such as that disclosed in the paper [Mullins et al, “Estimation Planar Patches from Light Field Reconstruction”, Proceedings of BMVC 2005, 2005].

The method may comprise the step of estimating the appearance of the object if it were evenly lit; the estimate may comprise an indication of the intensity of light reflected from each portion of the surface of the object in such a situation. To this end, the method may comprise minimising the entropy in the estimated appearance of the object. The method may comprise removing from the actual appearance of the object as determined from the images a bias function in order to calculate the estimated appearance of the object. The estimated intensity may also include information relating to the colour of the surface of the object.

The bias function may have parameters, the method comprising minimising the entropy in the estimated appearance of the object with respect to the parameters of the bias function. The use of the minimisation of entropy has been found to provide good results with minimal or no user interaction; the assumption is that the bias function will have added information into the observed images.

As entropy is a measure of the information content of, inter alia, images, its minimisation can be used to remove the information that has been added by the effects of lighting. The bias function therefore represents a model of how the object is lit, and may describe the light incident on the object passing through a spherical surface, typically a hemi-sphere, surrounding the object.

The entropy may be estimated according to:

H(\hat{X})˜−E[ln p(\hat{X})^{—}_{—}

where \hat{X} is a random variable describing the estimated intensity of the light reflected from the object if it were evenly lit, H is the entropy, E is the expected value of \hat{X} and p(\hat{X}) is the probability distribution function of \hat{X}.

The probability distribution function of \hat{X} may be estimated as a Parzen window estimated that takes a plurality of randomly chosen samples of the estimated intensity of light reflected from the object and uses those to form superpositions of a kernel function. This may be given by:

$$p ( u ; \hat{X} ) \approx \frac{1}{{N}_{A}} {\sum }_{x ∈ A} g ( u - \hat{X} ( x ) ; σ )$$

where g is a Gaussian distribution defined as:

$$g ( u ; σ ) = \frac{{e}^{- \frac{{u}^{2}}{2 {σ}^{2}}}}{\sqrt{2} πσ}$$

with σ as the standard deviation of the Gaussian function, A is the set of samples of object intensity and N_{A} is the number of samples in set A. σ is set to be a fraction 1/F of the intensity range of the data (typically F is in the range 10 to 30).

The expectation E of the estimated intensity may be calculated by taking the average of a second set of estimated intensity values estimated for points on the surface of the object. The expectation may be given by:

$$E [ \hat{X} ] \approx \frac{1}{{N}_{B}} {\sum }_{x ∈ B} \hat{X} ( x )$$

where B is the second set of samples.

The entropy may therefore be estimated by combining the above two estimations:

$$H ( \hat{X} ) \approx - \frac{1}{{N}_{B}} {\sum }_{x ∈ B} ln ( \frac{1}{{N}_{A}} {\sum }_{y ∈ A} g ( \hat{X} ( x ) - \hat{X} ( y ) ; σ ) )$$

The bias functions may be considered to be a combination of additive and multiplicative functions, such that the observed intensity at a point x on the surface of the model is given by:

Y(x)=X(x)S_{×}(x;Θ)+S₊(x;Θ)

where X(x) is the true intensity of light at a point x under even lighting conditions, S_{×}(x;Θ) and S₊(x;Θ) are multiplicative and additive bias functions respectively, and Θ are the parameters of the bias functions.

The estimate of the intensity \hat{X} can therefore be described as:

$$\hat{X} ( x ; {Θ}_{t} ) = \frac{Y ( x ) - {S}_{+} ( x ; {Θ}_{t} )}{{S}_{\times } ( x ; {Θ}_{t} )}$$

where Θₜ is a test set of bias function parameters.

The bias functions may be expressed as a combination of a plurality of spherical harmonic basis functions.

The method may comprise the step of estimating the entropy in the estimated appearance of the object, and then iteratively changing the parameters until the entropy is substantially minimised. This is computationally simple to achieve; the iteration may be terminated once the change in entropy per iteration reaches a lower limit.

The method may comprise calculating the differential of the estimate of the entropy and using that estimate to decide the size and/or direction of the change in parameters of the bias functions for the next iteration. The relation between the parameters of the bias functions for one iteration and the next may be expressed as:

$${Θ}_{t + 1} = {Θ}_{t} - {a}_{t} \frac{d H ( \hat{X} )}{d {Θ}_{t}}$$

where aₜ controls the step size. It should be selected such that the iteration, in general, converges.
aₜ may be given as:

$${a}_{t} = \frac{{a}_{0}}{{( 1 + t )}^{α}}$$

where a₀ is a constant (typically 1), α is a constant (typically 0.5) and t is the iteration number.

The method may also comprise determining, from the captured images, reflectance properties of the surface of the object and, in particular, the level of specular reflectance as distinguished from diffuse reflectance at points on the surface of the object. In order to achieve this, the method may comprise providing two camera sets, each comprising a plurality of spaced apart cameras, capturing images of the object with each of the cameras of the two sets, creating a three dimensional model of the object from the images from each of the camera sets, and determining from each model and the images of the respective set a lighting model describing how the object is lit, such that two lighting, such that two models of the object and two lighting models are generated, and comparing the two lighting models so as to determine the level of specular reflectance of the surface of the object. The determination may output an estimate of the bidirectional reflectance distribution function (BRDF) of the object.

The method may comprise using the lighting model to simulate the lighting of the object in a different position to that in which the images were captured. This allows simulation of the object being moved in the scene. The method may also comprise a further object in the scene captured by the cameras, so as to simulate the effect of the lighting and the presence of the further object on the appearance of both the object and the further object, to form a composite image. Accordingly, this allows the introduction of further objects into a scene that has been lit in an arbitrary fashion keeping the appearance of the original lighting. The method may further comprise the step of displaying the composite image.

According to a second aspect of the invention, there is provided a method of determining how a two-dimensional image is lit, comprising capturing the image, modelling the lighting of the image and removing the effects of the lighting, in which the method comprises calculating the entropy of the image with the effects of the lighting removed and selecting the model such that the entropy is minimised.

This therefore describes an extension of the first aspect of the invention to the two-dimensional situation.

The method may comprise removing from the images a bias function in order to calculate the estimated appearance of the image. The bias function may be a product of Legendre Polynomial Basis functions.

The bias function may have parameters, the method comprising minimising the entropy in the estimated appearance of the image with respect to the parameters of the bias function.

The entropy may be estimated according to:

H(\hat{X})˜−E[ln p(\hat{X})^{—}_{—}

where \hat{X} is a random variable describing the estimated intensity of the light reflected from the image if it were evenly lit, H is the entropy, E is the expected value of \hat{X} and p(\hat{X}) is the probability distribution function of \hat{X}.

The probability distribution function of \hat{X} may be estimated as a Parzen window estimated that takes a plurality of randomly chosen samples of the estimated intensity of light reflected from the image and uses those to form superpositions of a kernel function. This may be given by:

$$p ( u ; \hat{X} ) \approx \frac{1}{{N}_{A}} {\sum }_{x ∈ A} g ( u - \hat{X} ( x ) ; σ )$$

where g is a Gaussian distribution defined as:

$$g ( u ; σ ) = \frac{{e}^{- \frac{{u}^{2}}{2 {σ}^{2}}}}{\sqrt{2} πσ}$$

with σ as the standard deviation of the Gaussian, A is the set of samples of image intensity and N_{A} is the number of samples in set A. σ is set to be a fraction 1/F of the intensity range of the data (typically F is in the range 10 to 30).

The expectation E of the estimated intensity may be calculated by taking the average of a second set of estimated intensity values estimated for points on the surface of the image. The expectation may be given by:

$$E [ \hat{X} ] \approx \frac{1}{{N}_{B}} {\sum }_{x ∈ B} \hat{X} ( x )$$

where B is the second set of samples.

The entropy may therefore be estimated by combining the above two estimations:

$$H ( \hat{X} ) \approx - \frac{1}{{N}_{B}} {\sum }_{x ∈ B} ln ( \frac{1}{{N}_{A}} {\sum }_{y ∈ A} g ( \hat{X} ( x ) - \hat{X} ( y ) ; σ ) )$$

The bias functions may be considered to be a combination of additive and multiplicative functions, such that the observed intensity at a point x in the image is given by:

Y(x)=X(x)S_{×}(x;Θ)+S₊(x;Θ)

where X(x) is the true intensity of light at a point x under even lighting conditions, S_{×}(x;Θ) and S₊(x;Θ) are multiplicative and additive bias functions respectively, and Θ are the parameters of the bias functions.

The estimate of the intensity \hat{X} can therefore be described as:

$$\hat{X} ( x ; {Θ}_{t} ) = \frac{Y ( x ) - {S}_{+} ( x ; {Θ}_{t} )}{{S}_{\times } ( x ; {Θ}_{t} )}$$

where Θₜ is a test set of bias function parameters.

The method may comprise the step of estimating the entropy in the estimated appearance of the image, and then iteratively changing the parameters until the entropy is substantially minimised. This is computationally simple to achieve; the iteration may be terminated once the change in entropy per iteration reaches a lower limit.

The method may comprise calculating the differential of the estimate of the entropy and using that estimate to decide the size and/or direction of the change in parameters of the bias functions for the next iteration. The relation between the parameters of the bias function for one iteration and the next may be expressed as:

$${Θ}_{t + 1} = {Θ}_{t} - {a}_{t} \frac{d H ( \hat{X} )}{d {Θ}_{t}}$$

where aₜ controls the step size. It should be selected such that the iteration, in general, converges.
aₜ may be given as:

$${a}_{t} = \frac{{a}_{0}}{{( 1 + t )}^{α}}$$

where a₀ is a constant (typically 1), α is a constant (typically 0.5) and t is the iteration number.

According to a third aspect of the invention, there is provided a modelling apparatus, comprising a plurality of cameras at a known position from one another, a stage for an object and a control unit coupled to the cameras and arranged to receive images captured by the cameras, the control unit being arranged to carry out the method of the first aspect of the invention.

According to a fourth aspect of the invention, there is provided a modelling apparatus, comprising a camera, a stage for an object to be imaged, and a control unit coupled to the camera and arranged to receive images therefrom, in which the control unit is arranged to carry out the method of the second aspect of the invention.

There now follows, by way of example only, a description of several embodiments of the invention, described with reference to the accompanying drawings, in which:

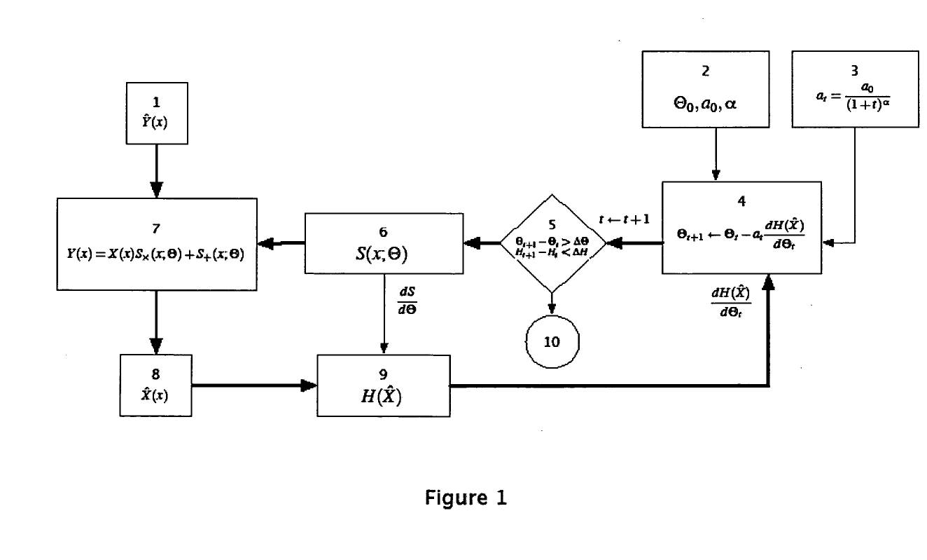

FIG. 1 shows a block diagram demonstrating the function of the entropy minimisation function of the embodiments of the present invention;

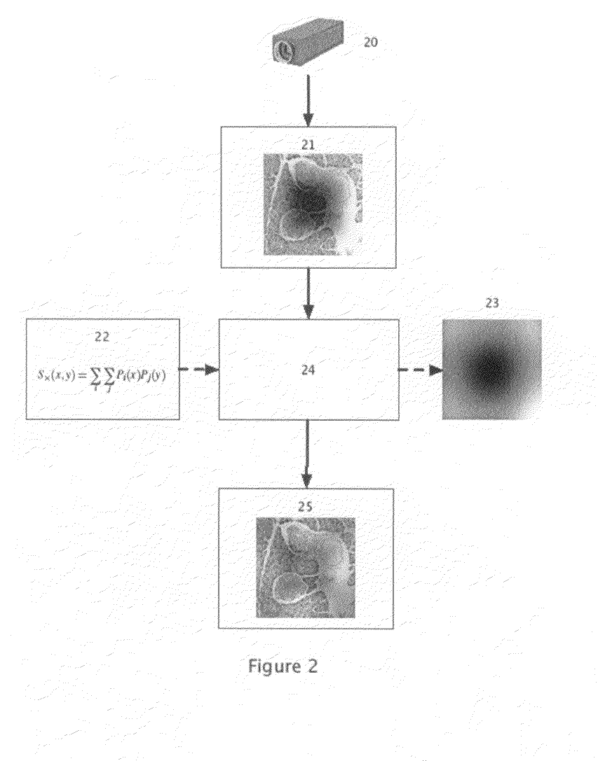

FIG. 2 shows a first embodiment of the invention applied to a two-dimensional image;

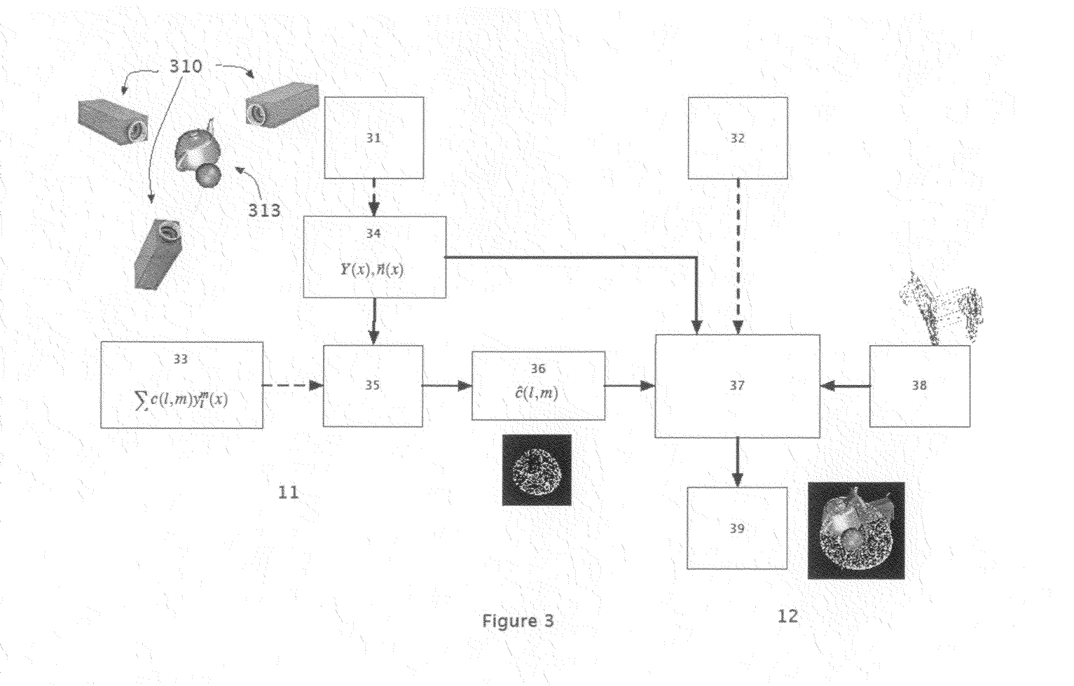

FIG. 3 shows a second embodiment of the invention applied to a three dimensional image; and

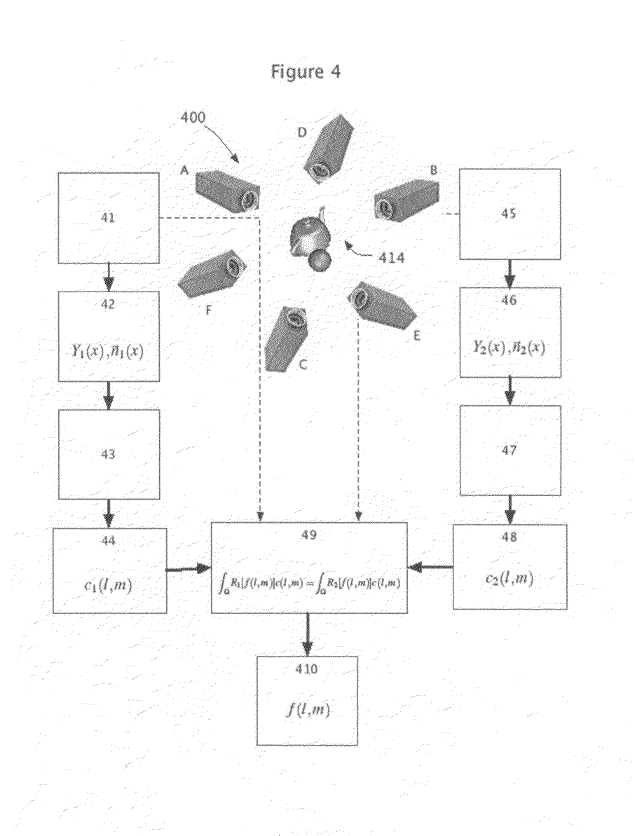

FIG. 4 shows a third embodiment of the invention applied to a three dimensional image.

FIG. 1 shows the operation of the entropy minimisation function used in the following embodiments of the invention. The main input Y(x) 1 to the function is a model of the observed intensity or colour of an object or image, be this two- or three-dimensional, as will be discussed below with reference to the individual embodiments.

The input 1 is fed into a model 7 of the effects of lighting on the true image. It is assumed that the image intensity is biased by unknown multiplicative and additive functions S_{×}(x;Θ) and S₊(x;Θ), which are functions of the position x within an image and a set of parameters Θ. The measured image intensity can therefore be considered as:

Y(x)=X(x)S_{×}(x;Θ)+S₊(x;Θ)

where X(x) is the true image intensity without any lighting effects. The model can therefore output an estimate \hat{X} 8 of the true image intensity at a point x by inverting the equation above as follows:

$$\hat{X} ( x ; {Θ}_{t} ) = \frac{Y ( x ) - {S}_{+} ( x ; {Θ}_{t} )}{{S}_{\times } ( x ; {Θ}_{t} )} .$$

However, this requires an estimate of the bias functions S_{×}(x;Θ) and S₊(x;Θ). Their estimation will be discussed below, but the functions should be differentiable with respect to their parameters.

In order to estimate the parameters that result in lowest entropy, an iterative process is used. This starts at step 2 with the initialisation of the parameters at some initial value Θ₀. This initialisation step also sets up the initial step size parameters a₀ and α as will be discussed below.

The assumption of this iterative process is that the bias in the observation will have added information, and hence entropy 9, of the true intensity X. At each step, a new set of parameters Θₜ₊₁ is chosen such that:

H(\hat{X}(x;Θₜ₊₁))<H(\hat{X}(x;Θₜ)).

In order to move from step to step, the method involves a gradient descent 4:

$${Θ}_{t + 1} = {Θ}_{t} - {a}_{t} \frac{d H ( \hat{X} )}{d {Θ}_{t}}$$

The parameter aₜ 3 controls the rate at which the parameters are changed from step to step and is given by:

$${a}_{t} = \frac{{a}_{0}}{{( 1 + t )}^{α}} .$$

At the initialisation step 2, a₀ is set to 1 and α is set to 0.5. The regulation of step size is important, as H(\hat{X}) is only an estimate of the true value. In the present case, we require an estimate of the entropy H(\hat{X}) 9 and its derivative with respect to the parameters Θ.

The Shannon-Wiener entropy 9 is defined as the negative expectation value of the natural log of the probability density function of a signal. Thus:

H(\hat{X})˜−E[ln p(\hat{X})^{—}_{—}

Two statistical methods are used to estimate the entropy. Firstly, the expectation, E[ ], of a random variable, X(x), can be approximated by a sample average over a set of B samples, e.g.:

$$E [ \hat{X} ] \approx \frac{1}{{{N}_{ }}_{R}} {\sum }_{x ∈ B} \hat{X} ( x )$$

The probability distribution function (pdf) of a random variable can be approximated by a Parzen window estimation that takes N_{A} superpositions of a set of kernel functions such as Gaussian functions

$$g ( u ; σ ) = \frac{{e}^{- \frac{{u}^{2}}{2 {σ}^{2}}}}{\sqrt{2} πσ} :$$

$$p ( u ; \hat{X} ) \approx \frac{1}{{N}_{A}} {\sum }_{x ∈ A} g ( u - \hat{X} ( x ) ; σ )$$

Gaussians are a good choice of kernel function because they can be controlled by a single parameter σ and they can be differentiated. A value of roughly 1/25 of the measured intensity range has been found to work satisfactorily; changing its value allows for a smooth curve for the calculation of entropy and allows use of a relative low size of sample sets A and B.

Sample sets A and B are taken randomly from the object or image in question. Suitable sizes of sample sets have been found to be 128 for A and 256 for B.

Combining the two equations above gives the following value for the entropy:

$$H ( \hat{X} ) \approx \frac{1}{{N}_{B}} {\sum }_{x ∈ B} ln ( \frac{1}{{N}_{A}} {\sum }_{y ∈ A} g ( \hat{X} ( x ) - \hat{X} ( y ) ; σ ) )$$

Given that both the pdf and the bias functions are differentiable, then the gradient of entropy H can be found. Substituting the above equation into the definition of \hat{X} above gives:

$$\frac{d}{d {Θ}_{\times }} \hat{X} ( x ) = - \frac{\frac{d}{d {Θ}_{\times }} {S}_{\times } ( x ; {Θ}_{\times } )}{{S}_{\times }^{2} ( x ; {Θ}_{\times } )} ( Y ( x ) - {S}_{+} ( x ; {Θ}_{+} ) )$$

$$\frac{d}{d {Θ}_{+}} \hat{X} ( x ) = - \frac{\frac{d}{d {Θ}_{+}} {S}_{+} ( x ; {Θ}_{\times } )}{{S}_{\times } ( x ; {Θ}_{\times } )} .$$

These derivatives can therefore be used to calculate the step size at step 4 described above.

The iterations terminate 10 if test 5 is satisfied: that is, that the change in entropy H is less than a predetermined limit ΔH or that the change in parameters Θ has reached a suitably small limit ΔΘ. At step 10, the estimated bias functions S_{×}(x;Θ) and S₊(x;Θ) are output, which describe the lighting of the image or object.

Several embodiments using this method of minimizing entropy will now be demonstrated. The first is discussed with reference to FIG. 2 of the accompanying drawings. This is a two-dimensional system, where a camera 20 captures an image 21 that has some lighting artefacts which it is desired to remove. A multiplicative bias function S_{×}(x,y;Θ) 22 is employed, which describes the intensity of the light at a point at Cartesian coordinates (x,y). This is expressed as a product of Legendre Polynomial basis functions:

$${S}_{\times } ( x , y ; Θ ) = {\sum }_{i = 0}^{M} {\sum }_{j = i}^{M - i} c ( i , j ) {P}_{i} ( x ) {P}_{j} ( y )$$

where c(ij) are the weights applied to the polynomials and hence are the parameters that are optimised and Pᵢ(x) and Pⱼ(y) are the Associated Legendre Polynomials. The number of polynomials used M controls the smoothness of the estimated bias field.

Accordingly, the entropy minimisation 24 of FIG. 1 is used. The differential of S_{×}(x,y;Θ) with respect to the parameters is given by:

$$\frac{d S ( x , y ; c ( i , j ) )}{d c ( i , j )} = {P}_{i} ( x ) {P}_{j} ( y ) .$$

Once the entropy minimisation has converged, the system outputs both an estimation of the lighting 23 based on the basis function but also a corrected “true” version of the image 25. As can be seen from the figures, the output image 25 is much clearer than the input 21.

A second embodiment of the invention can be seen in FIG. 3 of the accompanying drawings. A plurality of cameras 310 each capture an image of an object 313. The cameras are connected to a control unit comprising the functional blocks 31 to 39. The output of the cameras is passed to modelling unit 4, which forms a model of the shape of the object 313 according to a known method [Mullins et al, “Estimation Planar Patches from Light Field Reconstruction”, Proceedings of BMVC 2005, 2005]. The model comprises an estimate of the intensity of the captured light by the cameras at each point x on the surface Y(x) and a surface normal \vec{n}(x) showing the orientation of each portion of surface.

The lighting model 33 used in this embodiment—comprising the bias functions—is a sum of spherical harmonic basis functions:

Σc(l,m)yₗ^{m}(x)

where c(l,m) are the weightings that form the parameters of the bias functions that are to be minimised for entropy. These are well known functions that are easily differentiable.

At step 35, the entropy minimisation procedure of FIG. 1 is applied to provide a model of the lighting 36 parameterised by the estimated value of the coefficients ĉ(l,m). These define the Spherical Harmonic lighting approximation of the scene illumination 37. These can be combined with a desired viewing angle 32 and a further object 38 to provide a new composite view 39 of the object and the further object together taken from an angle different to that of any of the cameras. This uses common rendering techniques such as described in [Sloan, Kautz and Snyder. Precomputed Radiance Transfer for Real-Time Rendering in Dynamic, Low-Frequency Lighting Environments. ACM SIGGRAPH, 2002]. This composite scene 39 is output.

This can be further extended in the third embodiment of the invention shown with reference to FIG. 4 of the accompanying drawings. In this, two sets 400 of cameras A, B, C and D, E, F capture images of object 414. The views are passed to two separate image processing pipelines 41-44 and 45-48. Each pipeline processes the images from one camera set as described with reference to FIG. 3, but separately.

Accordingly, the images are captured at 41 and 45, separate models of the surfaces are made at 42 and 46, the entropy of the “true” appearance of the object is minimised separately at 43 and 47 to result in two different estimates of the lighting at 44 and 48. These therefore represent how the lighting appears from two different sets of view angles.

This can be used to determine the level of specular as opposed to diffuse reflection inherent in the object's surface. A linear system solver 49 is used to equate the reflectance of each surface patch and hence determine a parametric estimate of the bidirectional reflectance distribution function (BRDF) 410.

For the avoidance of doubt, we incorporate by reference all of the matter contained within our earlier United Kingdom Patent Application no 0616685.4, filed 23 Aug. 2006.

1. A method of modelling an object, comprising capturing images of the object from a plurality of spaced apart cameras, creating a three-dimensional model of the object from the images and determining from the model and the images a lighting model describing how the object is lit.

2. The method of claim 1, in which the cameras are at known positions relative to one another.

3. The method of claim 1, comprising the step of estimating the appearance of the object as if it were evenly lit to produce an estimated appearance; the estimated appearance comprising an estimated intensity of light reflected from each portion of the surface of the object in such a situation.

4. The method of claim 3, in which the estimated intensity includes information relating to the colour of the surface of the object.

5. The method of claim 3, comprising minimising entropy in the estimated appearance.

6. The method of claim 5, comprising removing from an actual appearance of the object as determined from the images a bias function in order to calculate the estimated appearance.

7. The method of claim 6, in which the bias function has parameters, the method comprising minimising the entropy in the estimated appearance with respect to the parameters of the bias function.

8. The method of claim 5, in which the entropy is estimated according to:
H(\hat{X})≈−E└lnp(\hat{X})_{—}
where H is the entropy, \hat{X} is a random variable describing the estimated intensity of the light reflected from the object if it were evenly lit having an expected value E and a probability distribution function p(\hat{X}).

9. The method of claim 8, in which the probability distribution function of \hat{X} is estimated as a Parzen window estimate that takes a plurality of randomly chosen samples of the estimated intensity of light reflected from the object and uses those to form superpositions of a kernel function.

10. The method of claim 9, in which the probability distribution function is estimated as:
$$p ( u ; \hat{X} ) \approx \frac{1}{{N}_{A}} {\sum }_{x ∈ A} g ( u - \hat{X} ( x ) ; σ )$$
where g is a Gaussian distribution defined as:
$$g ( u ; σ ) = \frac{{e}^{- \frac{{u}^{2}}{2 {σ}^{2}}}}{\sqrt{2} πσ}$$
with σ as the standard deviation of the Gaussian function, A is the set of samples of object intensity and N_{A} is the number of samples in set A.

11. The method of claim 8, in which the expectation E of the estimated intensity is calculated by taking the average of a second set of estimated intensity values estimated for points on the surface of the object.

12. The method of any of claims 8 to 12, in which the entropy is estimated as:
$$H ( \hat{X} ) \approx - \frac{1}{{N}_{B}} {\sum }_{x ∈ B} ln ( \frac{1}{{N}_{A}} {\sum }_{y ∈ A} g ( \hat{X} ( x ) - \hat{X} ( y ) ; σ ) )$$
where B is the second set of samples.

13. The method of claim 6, in which the bias functions are a combination of additive and multiplicative functions, such that the observed intensity at a point x on the surface of the model is given by:
Y(x)=X(x)S_{×}(x;Θ)+S₊(x;Θ)
where X(x) is the true intensity of light at a point x under even lighting conditions, S_{×}(x;Θ) and S₊(x;Θ) are multiplicative and additive bias functions respectively, and Θ are the parameters of the bias functions.

14. The method of claim 13, comprising estimating the intensity \hat{X} as:
$$\hat{X} ( x ; {Θ}_{t} ) = \frac{Y ( x ) - {S}_{+} ( x ; {Θ}_{t} )}{{S}_{\times } ( x ; {Θ}_{t} )}$$
where Θₜ is a test set of bias function parameters.

15. The method of claim 6, in which the bias functions are expressed as a combination of a plurality of spherical harmonic basis functions.

16. The method of claim 7, comprising the step of estimating the entropy in the estimated appearance of the object, and then iteratively changing the parameters until the entropy is substantially minimised.

17. The method of claim 16, comprising calculating the differential of the estimate of the entropy and using that estimate to decide the size and/or direction of the change in parameters of the bias functions for the next iteration.

18. The method of claim 1, comprising determining, from the captured images, reflectance properties of the surface of the object including, the level of specular reflectance as distinguished from diffuse reflectance at points on the surface of the object.

19. The method of claim 18, comprising providing two camera sets, each comprising a plurality of spaced apart cameras, capturing images of the object with each of the cameras of the two sets, creating a three dimensional model of the object from the images from each of the camera sets, and determining from each model and the images of the respective set a lighting model describing how the object is lit, such that two lighting, such that two models of the object and two lighting models are generated one for each set, and comparing the two lighting models so as to determine the level of specular reflectance of the surface of the object.

20. The method of claim 19, in which the determination outputs an estimate of the bidirectional reflectance distribution function (BRDF) of the object.

21. The method of any preceding claim, comprising using the lighting model to simulate the lighting of the object in a different position to that in which the images were captured.

22. The method of any preceding claim, comprising the simulation of a further object in the scene captured by the cameras, so as to simulate the effect of the lighting and the presence of the further object on the appearance of both the object and the further object, to form a composite image.

23. A method of determining how a two-dimensional image is lit, comprising capturing the image, modelling the lighting of the image and removing the effects of the lighting, in which the method comprises calculating the entropy of the image with the effects of the lighting removed and selecting the model such that the entropy is minimised.

24. The method of claim 23, comprising removing from the images a bias function in order to calculate the estimated appearance of the image.

25. The method of claim 24, in which the bias function is a product of associated Legendre Polynomial Basis functions.

26. The method of claim 24, in which the bias function has parameters, the method comprising minimising the entropy in the estimated appearance of the image with respect to the parameters of the bias function.

27. The method of any of claims 23, in which the entropy is estimated according to:
H(\hat{X})≈−E└lnp(\hat{X})_{—}
where H is the entropy, \hat{X} is a random variable describing the estimated intensity of the light reflected from the image if it were evenly lit having an expected value E and a probability distribution function p(\hat{X}).

28. The method of claim 30, in which the probability distribution function of \hat{X} is estimated as a Parzen window estimated that takes a plurality of randomly chosen samples of the estimated intensity of light reflected from the image and uses those to form superpositions of a kernel function.

29. The method of claim 28, in which the probability distribution function is given by:
$$p ( u ; \hat{X} ) \approx \frac{1}{{N}_{A}} {\sum }_{x ∈ A} g ( u - \hat{X} ( x ) ; σ )$$
where g is a Gaussian distribution defined as:
$$g ( u ; σ ) = \frac{{e}^{- \frac{{u}^{2}}{2 {σ}^{2}}}}{\sqrt{2} πσ}$$
with σ as the standard deviation of the Gaussian, A is the set of samples of image intensity and N_{A} is the number of samples in set A.

30. The method of any of claim 27, in which the expectation E of the estimated intensity is calculated by taking the average of a second set of estimated intensity values estimated for points on the image.

31. The method of claim 27, in which the entropy is estimated as:
$$H ( \hat{X} ) \approx \frac{1}{{N}_{B}} {\sum }_{x ∈ B} ln ( \frac{1}{{N}_{A}} {\sum }_{y ∈ A} g ( \hat{X} ( x ) - \hat{X} ( y ) ; σ ) )$$

32. The method of claim 24, in which the bias functions are a combination of additive and multiplicative functions, such that the observed intensity at a point x in the image is given by:
Y(x)=X(x)S_{×}(x;Θ)+S₊(x;Θ)
where X(x) is the true intensity of light at a point x under even lighting conditions, S_{×}(x;Θ) and S₊(x;Θ) are multiplicative and additive bias functions respectively, and Θ are the parameters of the bias functions.

33. The method of claim 23, comprising the step of estimating the entropy in the estimated appearance of the image, and then iteratively changing the parameters until the entropy is substantially minimised.

34. The method of claim 33, comprising calculating the differential of the estimate of the entropy and using that estimate to decide the size and/or direction of the change in parameters of the bias functions for the next iteration.

35. A modelling apparatus comprising a plurality of cameras at a known position from one another, a stage for an object and a control unit coupled to the cameras and arranged to receive images captured by the cameras, the control unit being arranged to create a three-dimensional model of the object from the images and determine from the model and the images a lighting model describing how the object is lit.

34. A modelling apparatus comprising a camera, a stage for an object to be imaged, and a control unit coupled to the camera and arranged to receive images therefrom, in which the control unit is arranged to model the lighting of the image and removing the effects of the lighting, in which the method comprises calculating the entropy of the image with the effects of the lighting removed and selecting the model such that the entropy is minimised.
